(19) United States
(12) Patent Application Publication
(10) Pub. No.: US 2015/0169874 A1
(43) Pub. Date: Jun. 18, 2015

(54) METHOD, DEVICE, AND SYSTEM FOR IDENTIFYING SCRIPT VIRUS

(71) Applicant: Tencent Technology (Shenzhen) Company Limited, Shenzhen (CN)

(72) Inventor: Jingbing CUI, Shenzhen (CN)

(73) Assignee: Tencent Technology (Shenzhen) Company Limited, Shenzhen (CN)

(21) Appl. No.: 14/614,171

(22) Filed: Feb. 4, 2015

Related U.S. Application Data
(63) Continuation of application No. PCT/CN2014/076085, filed on Apr. 24, 2014.

(30) Foreign Application Priority Data
May 15, 2013 (CN) 201310179635.8

(51) Int. Cl. G06F 21/56

(52) U.S. Cl. CPC G06F 21/561

(57) ABSTRACT

A method, a device and a system for identifying script virus are provided to improve identification rate of the script virus. The method includes: loading a script file runtime environment; setting, in the script file runtime environment, a characteristic function capturing function, correspondence between the characteristic function capturing function and a characteristic function, and a virus characteristic, by loading and running a characteristic script in the script file runtime environment; searching for the characteristic function in a script to be searched by loading and running the script to be searched in the script file runtime environment, replacing the characteristic function with the corresponding characteristic function capturing function, and obtaining executable codes in the characteristic function; determining whether the executable codes meet the virus characteristic; and reporting that the script to be searched is script virus if the executable codes meet the virus characteristic.

The present application is a continuation of International application PCT/CN2014/076085, filed on Apr. 24, 2014 which claims the priority to Chinese Patent Application No. 201310179635.8, entitled as “METHOD, DEVICE, AND SYSTEM FOR IDENTIFYING SCRIPT VIRUS”, filed on May 15, 2013 with State Intellectual Property Office of People's Republic of China, which are incorporated herein by reference in their entireties.

### TECHNICAL FIELD

The present disclosure relates to information security technology, and in particular, to a method, a device, and a system for identifying script virus.

### BACKGROUND

Script virus is a virus written in script languages. The script language is flexible, and multiple script virus variations having a same malicious behavior may be obtained by slightly changing the structure or content of the script file codes. In the prior art, one virus characteristic only can be used to find one script virus variation by scanning the script file codes, and thus the hit rate for identifying the script virus is low.

### SUMMARY

In view of the above, a method, a device and a system for identifying script virus are provided by embodiments of the disclosure.

A method for identifying script virus is provided, where the method includes: loading a script file runtime environment; setting, in the script file runtime environment, a characteristic function capturing function, correspondence between the characteristic function capturing function and a characteristic function, and a virus characteristic, by loading and running a characteristic script in the script file runtime environment; searching for the characteristic function in a script to be searched, replacing the characteristic function with the corresponding characteristic function capturing function, and obtaining executable codes in the characteristic function, by loading and running the script to be searched in the script file runtime environment; determining whether the executable codes meet the virus characteristic; and reporting that the script to be searched is script virus if the executable codes meet the virus characteristic.

A device for identifying script virus is provided, and the device includes: a loading unit, configured to load a script file runtime environment; an initialization unit, configured to set, in the script file runtime environment, a characteristic function capturing function, correspondence between the characteristic function capturing function and a characteristic function, and a virus characteristic, by loading and running a characteristic script in the script file runtime environment; an obtaining unit, configured to search for the characteristic function in a script to be searched, replace the characteristic function with the corresponding characteristic function capturing function, and obtain executable codes in the characteristic function, by loading and running the script to be searched in the script file runtime environment; a second determination unit, configured to determine whether the executable codes meet the virus characteristic; and a virus report unit, configured to report that the script to be searched is script virus if the executable codes meet the virus characteristic.

A system for identifying script virus is further provided, and the system includes: a characteristic virus library and a virus identification engine, where the characteristic virus library is configured to store a plurality of characteristic scripts; and the virus identification engine is the above device for identifying script virus.

### BRIEF DESCRIPTION OF THE DRAWINGS

FIG. 1 is a flow chart of a method for identifying script virus according to embodiments of the disclosure;

FIG. 2 is a flow chart of a method for identifying script virus according to embodiments of the disclosure;

FIG. 3 is a flow chart of a method for identifying script virus according to embodiments of the disclosure;

FIG. 4 is a schematic diagram of a device for identifying script virus according to embodiments of the disclosure;

FIG. 5 is a schematic diagram of an initialization unit in a device for identifying script virus according to embodiments of the disclosure;

FIG. 6 is a schematic diagram of an obtaining unit in a device for identifying script virus according to embodiments of the disclosure;

FIG. 7 is a schematic diagram of a device for identifying script virus according to embodiments of the disclosure;

FIG. 8 is a schematic diagram of a system for identifying script virus according to embodiments of the disclosure; and

FIG. 9 is a schematic structure diagram of a terminal according to embodiments of the disclosure.

### DETAILED DESCRIPTION OF THE EMBODIMENTS

For making the objects, features and advantages of the disclosure more apparent and understandable, embodiments of the disclosure are described in detail hereinafter in conjunction with the drawings.

The embodiments of the disclosure are described from a point of a device for identifying script virus. The device for identifying script virus may be integrated into a client device, and the client device may be installed in a terminal The terminal may be, for example, a smart phone, a tablet computer, an e-book reader, a Moving Picture Experts Group Audio Layer III (MP3) Player, a Moving Picture Experts Group Audio Layer IV (MP4) Player, a laptop or a desktop.

In view of the low hit rate for identifying the script virus conventionally, scanning for virus characteristic is not performed on the script virus codes in the embodiment; instead, a characteristic script and a script to be searched are run in a script file runtime environment, and if the script to be searched is a virus script, i.e., the script to be searched meets a preset initialization characteristic condition, the virus script may continue running and real malicious executable codes hidden in the virus script are identified. In this way, although there are multiple variations of the virus script codes, the real malicious executable codes in the virus script can be obtained, and the scanning for virus characteristic is performed on the executable codes, therefore, script viruses having the same malicious behavior can be identified by a characteristic script.

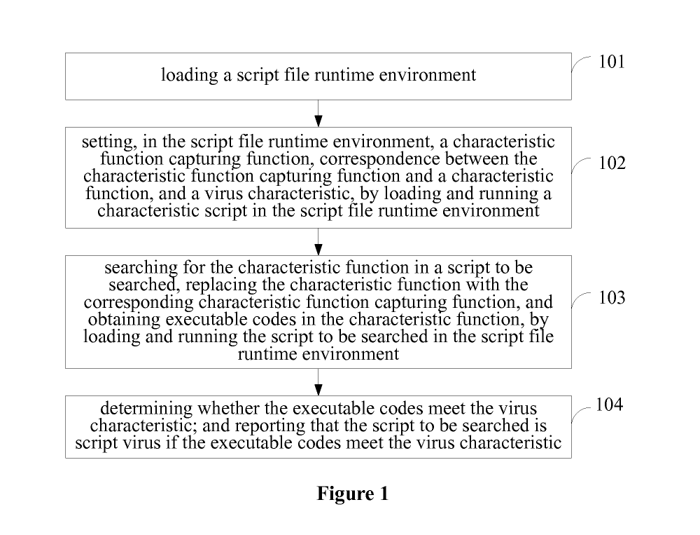

Reference is made to FIG. 1, which illustrates a method for identifying script virus according to embodiments of the disclosure. The method includes steps 101-104.

Step 101 may include, loading a script file runtime environment.

The script file runtime environment may be loaded by loading a virtual machine. Taking the case that a characteristic script and a script to be searched are both written in JavaScript language as an example, the script file runtime environment may be provided by loading a JavaScript virtual machine (i.e., JS virtual machine). The JS virtual machine may simulate an execution environment of JavaScript, for example, provide some JavaScript's built-in functions, and may also execute JavaScript script. In the embodiment, the JS virtual machine is mainly used to execute the characteristic script and the script to be searched.

In the embodiment, the identification of the script virus may be triggered when a user clicks a button for scanning, or when a file monitoring system identifies that there is a file loaded locally, or when a script file is required to be executed during browsing a webpage, etc.

Step 102 may include, setting a characteristic function capturing function, correspondence between the characteristic function capturing function and a characteristic function, and a virus characteristic in the script file runtime environment by loading and running the characteristic script in the script file runtime environment.

Multiple characteristic scripts may be stored in a characteristic virus library. New characteristic script may be added in real time and the characteristic scripts stored in the characteristic virus library may be updated in real time. Each characteristic script is used to identify a corresponding script virus. The characteristic script is loaded and executed in the script file runtime environment.

Taking JavaScript language as an example, the characteristic function capturing function and the correspondence between the characteristic function capturing function and the characteristic function are set, and Hook JS may be adopted. Hook is used to change a call which is to call one function to a call which is to call another function. Therefore, after the correspondence between the characteristic function capturing function and the characteristic function is set, a call which is to call a characteristic function may be changed to a call which is to call a prepared characteristic function capturing function when the characteristic function is called by the script.

If the script to be searched is script virus, the characteristic function is used to execute executable codes in the characteristic function itself. However, it is set that the characteristic function is replaced with the characteristic function capturing function, that is, a call which is to call the characteristic function is changed to a call which is to call the characteristic function capturing function when the characteristic function is called by the script to be searched, where the characteristic function capturing function is used to obtain character strings of the executable codes in the function body of the characteristic function. In this way, the executable codes in the characteristic function are obtained, rather than executed, and scanning for virus characteristic may be performed on the executable codes.

Step 103 may include, searching for the characteristic function in the script to be searched by loading and running the script to be searched in the script file runtime environment, replacing the characteristic function with a corresponding characteristic function capturing function, and obtaining the executable codes in the characteristic function.

The characteristic function is a function which can execute the executable codes in the characteristic function itself, and the characteristic function capturing function is a function which can obtain character strings of the executable codes in the function body of the characteristic function. If the characteristic function is to be called by the characteristic script, the characteristic function capturing function is called instead of the characteristic function. There may be two cases for obtaining the executable codes in the characteristic function. In one case that the function body of the characteristic function is executable codes, the executable codes in the characteristic function is directly obtained. That is, the function body itself of the characteristic function is the executable codes, and the character strings of the executable codes may be obtained by replacing the characteristic function with the corresponding characteristic function capturing function. In another case that a sub-function is nested in the characteristic function, the executable codes in the characteristic function may be obtained by running the sub-function in the characteristic function. That is, in a case that a sub-function is nested in the function body of characteristic function, the executable codes may be obtained by running the sub-function, the characteristic function including the sub-function is converted into the characteristic function including the executable codes, then the characteristic function is replaced with the corresponding characteristic function capturing function, and the executable codes in the characteristic function may be obtained.

Step 104 may include, determining whether the executable codes meet the virus characteristic, and reporting that the script to be searched is script virus if the executable codes meet the virus characteristic.

The virus may be preset in the characteristic script, and if the executable codes meet the virus characteristic, a callback function report provided in the script file runtime environment may be used to report the virus.

Based on the embodiment, an initialization characteristic condition may further be set in the script file runtime environment by loading and running the characteristic script in the script file runtime environment. Before searching for the characteristic function in the script to be searched, it may be determined whether the script to be searched meets the initialization characteristic condition by loading and running the script to be searched in the script file runtime environment; if the script to be searched meets the initialization characteristic condition, the characteristic function in the script to be searched is searched for and replaced with the corresponding characteristic function capturing function, and the executable codes in the characteristic function are obtained.

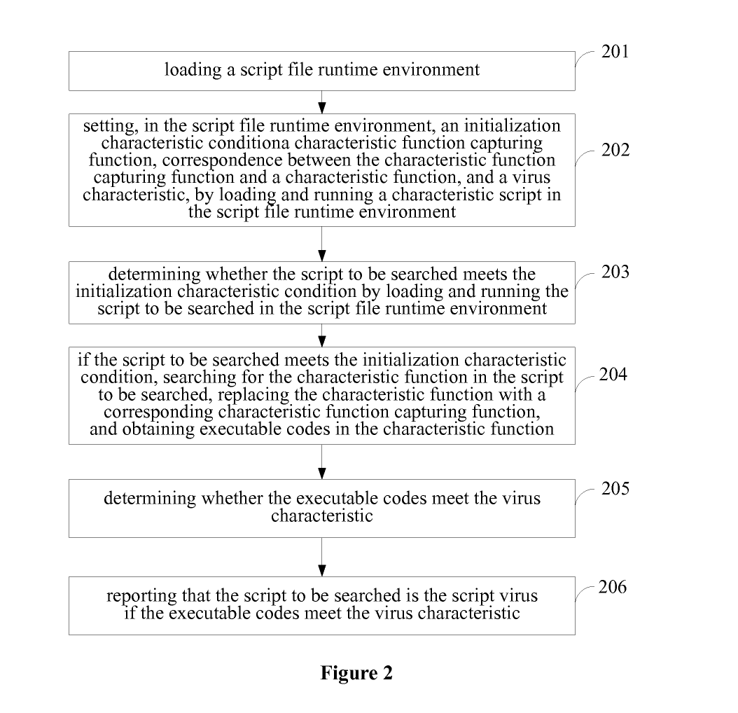

Reference is made to FIG. 2, which illustrates a method for identifying script virus according to embodiments of the disclosure. The method includes steps 201-206.

Step 201 may include, loading a script file runtime environment.

Step 202 may include, setting an initialization characteristic condition, a characteristic function capturing function, correspondence between the characteristic function capturing function and a characteristic function, and a virus characteristic in the script file runtime environment by loading and running a characteristic script in the script file runtime environment.

The initialization characteristic condition may be set in the script file runtime environment by loading and running the characteristic script in the script file runtime environment. The initialization characteristic condition set by running the characteristic script is used to, in a case that a script to be searched is script virus, simulate an initialization condition of the script virus to make the script virus continue running until real executable codes in the script virus are exposed.

The process of setting the initialization characteristic condition may include: declaring a characteristic initialization global variable and a characteristic initialization function; setting a first execution result, which is generated by using the characteristic initialization global variable and calling the characteristic initialization function, as the initialization condition.

An example is taken to further explain the declaration of the characteristic initialization global variable, the declaration of the characteristic initialization function, and the function of Hook JS.

The characteristic initialization global variable is declared, for example, a global variable document is declared with var document=new Object( ) then the variable may be used by scripts running in the same script file runtime environment subsequently.

The characteristic initialization function is declared, for example, a function Add is declared with function Add(num1, num2){return num1+num2,}, then the function may be called by scripts running in the same script file runtime environment subsequently. For example, if var addresult=Add(2, 3) is executed by a subsequent script, the declared function Add is executed, and an actual execution result is addresult=5.

Hook JS is used to change a call which is to call one function to a call which is to call another function. For example, the above function Add is to add input parameters together and return the result of adding. A new function myAdd(num1, num2){return num1*num2} may be set, then a script add=myAdd is executed. Therefore, the new function myAdd is called when executing var addresult=Add(2, 3), where function myAdd is to multiply input parameters and return the result of multiplying, and consequently the actual execution result is addresult=6.

Step 203 may include, determining whether the script to be searched meets the initialization characteristic condition by loading and running the script to be searched in the script file runtime environment.

When the script to be searched is loaded and run in the script file runtime environment, the script to be searched may generate a second execution result by using the characteristic initialization global variable and calling the characteristic initialization function set in the script file runtime environment. Then it is determined whether the second execution result is the same as the initialization characteristic condition; if the second execution result is the same as the initialization characteristic condition, the script to be searched meets the initialization characteristic condition; and if the second execution result is not the same as the initialization characteristic condition, the script to be searched does not meet the initialization characteristic condition.

If the script to be searched meets the initialization characteristic condition, the script to be searched may continue running in the pre-simulated virus running environment, and the running result of the script to be searched needs to be further determined. If the script to be searched does not meet the initialization characteristic condition, the script to be searched does not meet the script virus characteristic with respect to the characteristic script being used.

Step 204 may include, if the script to be searched meets the initialization characteristic condition, the characteristic function is searched for in the script to be searched and is replaced with a corresponding characteristic function capturing function, and executable codes in the characteristic function are obtained.

Step 205 may include, determining whether the executable codes meet the virus characteristic.

Step 206 may include, reporting that the script to be searched is script virus if the executable codes meet the virus characteristic.

Based on the above embodiment, the method for identifying script virus may further include, before running the script to be searched in the script file runtime environment,

determining whether a file to be searched is a script file; in a case that the file to be searched is a script file, taking the file to be searched as the script to be searched; and in a case that the file to be searched is not a script file and the file to be searched includes a script file, extracting the script file from the file to be searched and taking the extracted script file as the script to be searched.

The script to be searched may be directly run, or embedded in a webpage or a Pdf file. In a case that the script to be searched is embedded in the webpage or the Pdf file, the script to be searched is required to be extracted.

For example, in a case that JavaScript codes are embedded in an Html webpage file, matching is performed on the Html webpage file by <script[̂>]*>([\s\S]*?)</script>, and the matched contents are the JavaScript codes, which may be extracted and taken as the script to be searched.

For example, in a case that JavaScript codes are embedded in the Pdf file, matching is performed on the Pdf file by javascript/js\(([\s\S]*?[̂\\])\), and the matched contents are the JavaScript codes, which may be extracted and taken as the script to be searched.

In addition, a characteristic virus library may include multiple characteristic scripts, in this case, steps 202-206 are repeated for the multiple characteristic scripts one by one, until it is reported that the script to be searched is script virus, or all of the characteristic scripts are compared. If one script to be searched is not determined as a script virus after being compared with all the characteristic scripts, it may be concluded that the script to be searched is not script virus.

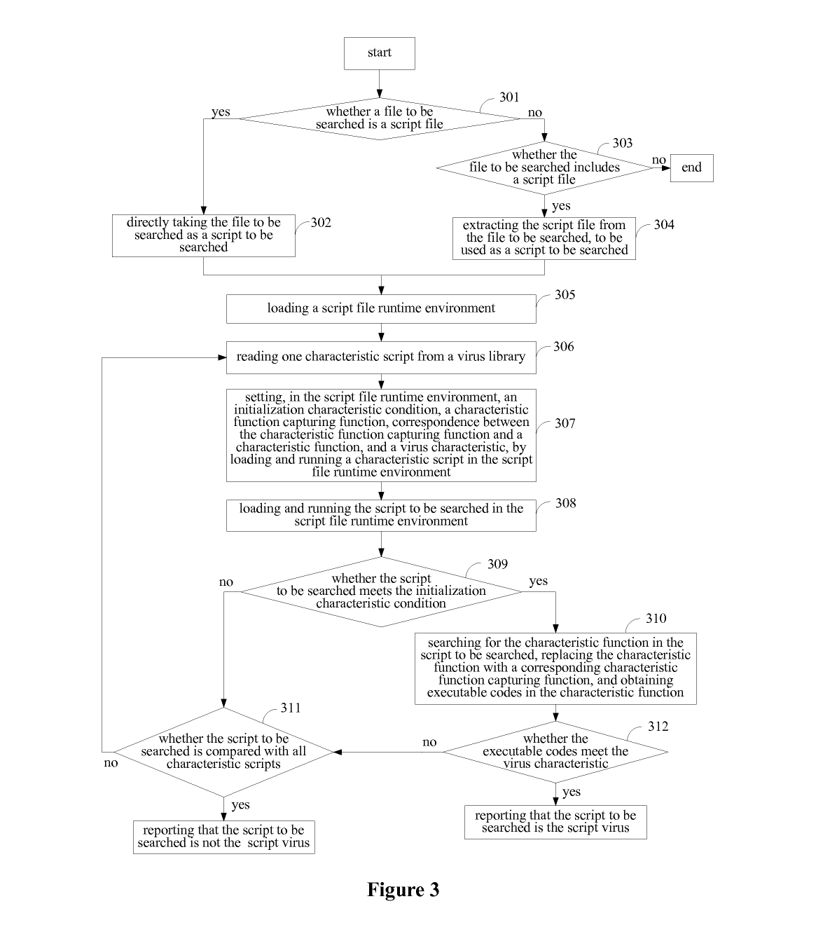

Reference is made to FIG. 3, which illustrates a method for identifying script virus according to embodiments of the disclosure. The method may include steps 301-312.

Step 301 may include, determining whether a file to be searched is a script file; if the file to be searched is a script file, proceeding to step 302; and if the file to be searched is not a script file, proceeding to step 303.

Step 302 may include, taking the file to be searched as a script to be searched.

Step 303 may include, determining whether the file to be searched includes a script file; if the file to be searched includes a script file, proceeding to step 304; and if the file to be searched does not include a script file, ending.

Step 304 may include, extracting the script file from the file to be searched, and take the script file as a script to be searched.

Step 305 may include, loading a script file runtime environment.

Step 306 may include, reading a characteristic script from a virus library.

Step 307 may include, setting an initialization characteristic condition, a characteristic function capturing function, correspondence between the characteristic function capturing function and a characteristic function, and a virus characteristic in the script file runtime environment by loading and running a characteristic script in the script file runtime environment.

A characteristic initialization global variable and a characteristic initialization function may be declared; a first execution result, which is generated by using the characteristic initialization global variable and calling the characteristic initialization function, may be set as an initialization condition; and meanwhile the characteristic function capturing function, the correspondence between the characteristic function capturing function and the characteristic function, and the virus characteristic may be set.

It should be noted that, steps 301-304 may be performed after any one of steps 305-307, which is not limited in the embodiments of the disclosure.

Step 308 may include loading and running the script to be searched in the script file runtime environment.

Step 309 may include determining whether the script to be searched meets the initialization characteristic condition; if the script to be searched meets the initialization characteristic condition, proceeding to step 310; and if the script to be searched does not meet the initialization characteristic condition, proceeding to step 311.

A second execution result may be generated by the script to be searched by using the characteristic initialization global variable and calling the characteristic initialization function. It is determined whether the second execution result meets the initialization characteristic condition, to determine whether the script to be searched meets the initialization characteristic condition.

Step 310 may include, searching for the characteristic function in the script to be searched, replacing the characteristic function with a corresponding characteristic function capturing function, and obtaining executable codes in the characteristic function.

In a case that a function body of the characteristic function is executable codes, the executable codes in the characteristic function are obtained directly. In a case that a sub-function is nested in the function body of the characteristic function, the executable codes in the characteristic function are obtained by running the sub-function in the characteristic function.

Step 311 may include determining whether the script to be searched is compared with all characteristic scripts; if the script to be searched is compared with all characteristic scripts, reporting that the script to be searched has no virus; and if the script to be searched is not compared with all characteristic scripts, returning to step 306.

Step 312 may include determining whether the executable codes meet the virus characteristic; if the executable codes meet the virus characteristic, reporting that the script to be searched is script virus; and if the executable codes do not meet the virus characteristic, returning to step 311.

The above embodiment is explained by a specific example. In the example, the characteristic script and the script to be searched are both written in JavaScript language.

A script file runtime environment is loaded; and the characteristic script is loaded and run in the script file runtime environment, where the characteristic script is as follows:

var document = new Object( )
function hookIndexOf(str)
{return −1}
var cookie = new Object( )
cookie.indexOf = hookIndexOf
document.cookie = cookie
var orgeval = eval
function hookEval(str)
{
if(str.indexOf(“x169.net”)>0)
{ report (“virus”) }
else{orgeval(str)}
}
eval = hookEval

After running the characteristic script, in the script file runtime environment, characteristic initialization global variables document and cookie are declared, and cookie attribute of document is set as cookie; a characteristic initialization function hookIndexOf is declared, and indexOf attribute of cookie is set as function hookIndexOf, here a hook process is finished, i.e., function indexOf of cookie is hooked. An initialization characteristic condition is set as: an execution result of a statement document.cookie.indexOf(‘helio’), which appears in running a virus script, is −1.

A characteristic function capturing function hookEval, and correspondence between the characteristic function capturing function hookEval and a characteristic function Eval are declared, that is, a hook process is finished by setting the function Eval as the function hookEval, therefore, if the function Eval is called in the script file runtime environment, the function hookEval is called instead of the function Eval. The virus characteristic is set as x169.net, that is, it is determined whether x169.net is included in executable codes.

The script to be searched is loaded and run in the script file runtime environment, the script to be searched is as follows (only key codes are illustrated):

If(document.cookie.indexOf(‘helio’) ==−1)
{/*ellipsis*/
eval (/* ellipsis */)}

For If(document.cookie.indexOf(‘helio’)==−1) in the script to be searched, attribute indexOf of variable cookie in variable document is executed. Since the corresponding characteristic initialization global variables and characteristic initialization function are set in the script file runtime environment by running the characteristic script, a second execution result may be obtained by using the characteristic initialization global variables and the characteristic initialization function; in the example, the execution result of document.cookie.indexOf(‘helio’) is −1, which meets the initialization characteristic condition, so the script continues being searched.

When the characteristic function Eval is searched, the function Eval is replaced with the function hookEval, however, a sub-function nested in the function Eval continues being executed to generate executable codes:

document.writeln(<script language=javascript
src = “http://bbs.xcdx169.net/include/log.js?fegf”> </script>”)

then character strings of the executable codes may be obtained by the function hookEval.

It is determined whether the executable codes include virus characteristic x169.net; and if the executable codes include virus characteristic x169.net, report (“virus”) is executed, that is, it is reported that the file to be searched is script virus.

Based on the above, in the embodiments of the disclosure, the characteristic script and the script to be searched are loaded and run in the script file runtime environment, the initialization characteristic condition is preset; if the script to be searched meets the initialization characteristic condition, the script to be searched may be script virus, and the script to be searched may continue being run in the pre-simulated script virus runtime environment until the characteristic function is found, where the characteristic function is used to execute the executable codes included in the characteristic function; the characteristic function is replaced with the corresponding characteristic function capturing function, and the executable codes included in the characteristic function are obtained by the characteristic function capturing function, rather than executed by the characteristic function. In this way, the real executable behavior of the script to be searched is found; and then, by scanning the real executable codes hidden in the script to be searched for the virus characteristic, multiple virus variations having the same malicious behavior can be found by only one characteristic script, therefore, the hit rate for identifying the script virus is increased.

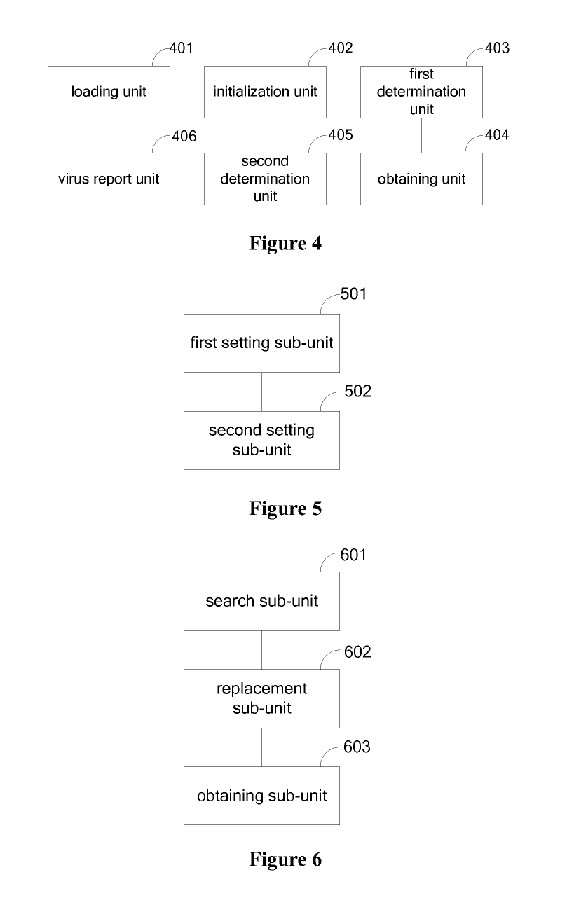

A device for identifying script virus is further provided according to embodiments of the disclosure. As shown in FIG. 4, the device includes: a loading unit 401, an initialization unit 402, an obtaining unit 404, a second determination unit 405, and a virus report unit 406.

The loading unit 401 is configured to load a script file runtime environment.

The initialization unit 402 is configured to set, in the script file runtime environment, a characteristic function capturing function, correspondence between the characteristic function capturing function and a characteristic function, and a virus characteristic, by loading and running a characteristic script in the script file runtime environment.

The obtaining unit 404 is configured to search for the characteristic function in a script to be searched, replace the characteristic function with the corresponding characteristic function capturing function, and obtain executable codes in the characteristic function, by loading and running the script to be searched in the script file runtime environment.

The second determination unit 405 is configured to determine whether the executable codes meet the virus characteristic.

The virus report unit 406 is configured to report that the script to be searched is script virus if the executable codes meet the virus characteristic.

Based on the above embodiment, the initialization unit may further be configured to set an initialization characteristic condition in the script file runtime environment by loading and running the characteristic script in the script file runtime environment;

then the device for identifying script virus may further include: a first determination unit 403, configured to determine whether the script to be searched meets the initialization characteristic condition by loading and running the script to be searched in the script file runtime environment,

and the obtaining unit is further configured to, in a case that the script to be searched meets the initialization characteristic condition, search for the characteristic function in the script to be searched, replace the characteristic function with the corresponding characteristic function capturing function, and obtain the executable codes in the characteristic function, by loading and running the script to be searched in the script file runtime environment.

As shown in FIG. 4, the initialization unit 402 may include: a first setting sub-unit 401 and a second setting sub-unit 402.

The first setting sub-unit 401 is configured to, by loading and running the characteristic script in the script file runtime environment, declare a characteristic initialization global variable and a characteristic initialization function, and set a first execution result, which is generated by using the characteristic initialization global variable and calling the characteristic initialization function, as the initialization characteristic condition, in the script file runtime environment.

The second setting sub-unit 402 is configured to declare the characteristic function capturing function and the correspondence between the characteristic function capturing function and the characteristic function, and set the virus characteristic.

The first determination unit 403 may be configured to:

by loading and running the script to be searched in the script file runtime environment, generate a second execution result by the script to be searched by using the characteristic initialization global variable and calling the characteristic initialization function; determine whether the second execution result is the same as the initialization characteristic condition; determine that the script to be searched meets the initialization characteristic condition if the second execution result is the same as the initialization characteristic condition; and determine that the script to be searched does not meet the initialization characteristic condition if the second execution result is not the same as the initialization characteristic condition.

As shown in FIG. 6, the obtaining unit 404 may include: a searching sub-unit 601, a replacement sub-unit 602, and an obtaining sub-unit 603.

The searching sub-unit 601 is configured to search for the characteristic function in the script to be searched by loading and running the script to be search in the script file runtime environment.

The replacement sub-unit 602 is configured to replace the characteristic function with the corresponding characteristic function capturing function.

The obtaining sub-unit 603 is configured to, in a case that a function body of the characteristic function is executable codes, obtain the executable codes in the characteristic function; and in a case that a sub-function is nested in the function body of the characteristic function, obtain the executable codes in the characteristic function by running the sub-function in the characteristic function.

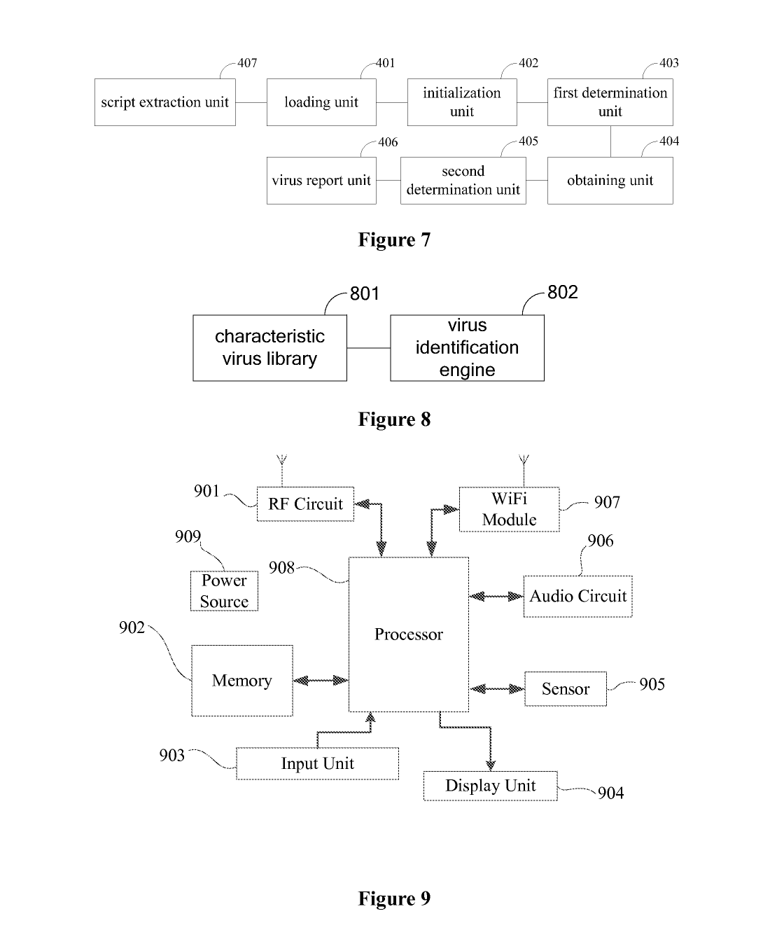

Referring FIG. 7, which illustrates a device for identifying script virus according to embodiments of the disclosure. The device may further include:

a script extraction unit 407, configured to determine whether a file to be searched is a script file; in a case that the file to be searched is a script file, take the file to be searched as the script to be searched; and in a case that the file to be searched is not a script file and the file to be searched includes a script file, extract the script file from the file to be searched and take the extracted script file as the script to be searched.

Correspondingly, a system for identifying script virus is further provided according to embodiments of the disclosure. As shown in FIG. 8, the system includes: a characteristic virus library 801 and a virus identification engine 802.

The characteristic virus library is configured to store multiple characteristic scripts. New characteristic script may be added in real time and the characteristic scripts stored in the characteristic virus library may be updated in real time.

The virus identification engine may be the device for identifying script virus according to the above embodiments of the disclosure.

The operating principle of the system according to the embodiments of the disclosure is described as follows.

The virus identification engine obtains a script to be searched and load a script file runtime environment; reads a characteristic script from the characteristic virus library, and sets an initialization characteristic condition, a characteristic function capturing function, correspondence between the characteristic function capturing function and a characteristic function, and a virus characteristic in the script file runtime environment by loading and running the characteristic script in the script file runtime environment; determines whether the script to be searched meets the initialization characteristic condition by loading and running the script to be searched in the script file runtime environment; in a case that the script to be searched meets the initialization characteristic condition, searches for the characteristic function in the script to be searched, replaces the characteristic function with a corresponding characteristic function capturing function, and obtains executable codes in the characteristic function; determines whether the executable codes meet the virus characteristic; and in a case that the executable codes meet the virus characteristic, reports the script to be searched as script virus.

Correspondingly, a terminal is further provided according to embodiments of the disclosure. As shown in FIG. 9, the terminal may include a Radio frequency (RF) circuit 901, a memory 902 including one or more computer readable medium, an input unit 903, a display unit 904, a sensor 905, an audio circuit 906, a Wireless Fidelity (WiFi) module 907, a processor 908 including one or more processing cores, a power source 990, etc. It should be understood by those skilled in the art that, the structure of the terminal shown in FIG. 9 is not intent to limit the terminal, more or less components than shown in FIG. 9 may be included, some components may be combined or arranged in a different manner

The RF circuit 901 may be configured to receive and transmit signals in information receiving and transmitting and telephone communication. Specifically, the RF circuit delivers the received downlink information of the base station to the processor 908 to be processed, and transmits the uplink data to the base station. Generally, the RF circuit 901 includes but not limited to an antenna, at least one amplifier, a turner, one or more oscillators, a Subscriber Identity Module (SIM) card, a transceiver, a coupler, a Low Noise Amplifier (LNA), and a duplexer. In addition, the RF circuit 901 may communicate with other devices via wireless communication and network. The wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), E-mail, and Short Messaging Service (SMS).

The memory 902 may be configured to store software programs and modules, and the processor 908 may execute various function applications and data processing by running the software programs and modules stored in the memory 902. The memory 902 may mainly include a program storage area and a data storage area, where the program storage area may be used to store, for example, the operating system and the application required by at least one function (for example, voice playing function, image playing function), and the data storage area may be used to store, for example, data established according to the use of the terminal (for example, audio data, telephone book). In addition, the memory 902 may include a high-speed random access memory and a nonvolatile memory, such as at least one magnetic disk memory, a flash memory, or other volatile solid-state memory. The memory 902 may also include a memory controller to provide access to the memory 902 for the processor 908 and the input unit 903.

The input unit 903 may be configured to receive input numeric or character information, and to generate a keyboard, a mouse, a joystick, an optical or trackball signal input related to user setting and function control. In a specific embodiment, the input unit 903 may include a touch-sensitive surface and other input device. The touch-sensitive surface is also referred to as a touch display screen or a touch pad, and may collect a touch operation thereon or thereby (for example, an operation on or around the touch-sensitive surface that is made by the user with a finger, a touch pen and any other suitable object or accessory), and drive corresponding connection devices according to a preset procedure. Optionally, the touch-sensitive surface may include a touch detection device and a touch controller. The touch detection device detects touch orientation of the user, detects a signal generated by the touch operation, and transmits the signal to the touch controller. The touch controller receives touch information from the touch detection device, converts the touch information into touch coordinates and transmits the touch coordinates to the processor 908. The touch controller is also able to receive a command transmitted from the processor 908 and execute the command. In addition, the touch-sensitive surface may be implemented by, for example, a resistive surface, a capacitive surface, an infrared surface and a surface acoustic wave surface. In addition to the touch-sensitive surface, the input unit 903 may also include other input device. Specifically, the other input device may include but not limited to one or more of a physical keyboard, a function key (such as a volume control button, a switch button), a trackball, a mouse and a joystick.

The display unit 904 is configured to display information input by the user or information provided for the user and various graphical user interfaces (GUI) of the terminal, these GUIs may be formed by a graph, a text, an icon, a video and any combination thereof. The display unit 904 may include a display panel. Optionally, the display panel may be formed in a form of a Liquid Crystal Display (LCD), an Organic Light-Emitting Diode (OLED) or the like. In addition, the display panel may be covered by the touch-sensitive surface. When the touch-sensitive surface detects a touch operation thereon or thereby, the touch-sensitive surface transmits the touch operation to the processor 908 to determine the type of the touch event, and then the processor 908 provides a corresponding visual output on the display panel according to the type of the touch event. Although the touch-sensitive surface and the display panel implementing the input and output functions as two separate components in FIG. 9, the touch-sensitive surface and the display panel may be integrated together to implement the input and output functions in other embodiment.

The terminal may further include at least one sensor 905, such as an optical sensor, a motion sensor and other sensors. The optical sensor may include an ambient light sensor and a proximity sensor. The ambient light sensor may adjust the luminance of the display panel 231 according to the intensity of ambient light, and the proximity sensor may close the backlight or the display panel 231 when the terminal is approaching to the ear. As a kind of motion sensor, the gravity acceleration sensor may detect the magnitude of acceleration in multiple directions (usually three-axis directions) and detect the value and direction of the gravity when the sensor is in the stationary state. The acceleration sensor may be applied in, for example, an application of mobile phone pose recognition (for example, switching between landscape and portrait, a correlated game, magnetometer pose calibration), a function about vibration recognition (for example, a pedometer, knocking). Other sensors such as a gyroscope, a barometer, a hygrometer, a thermometer, an infrared sensor, which may be further provided in the terminal, are not described herein.

The audio circuit 906, a loudspeaker and a microphone may provide an audio interface between the user and the terminal The audio circuit 906 may transmit an electric signal, converted from received audio data, to the loudspeaker, and a voice signal is converted from the electric signal and then outputted by the loudspeaker. The microphone converts captured voice signal into an electric signal, the electric signal is received by the audio circuit 906 and converted into audio data. The audio data is outputted to the processor 908 for processing and then sent to another terminal via the RF circuit 901; or the audio data is outputted to the memory 902 for further processing. The audio circuit 906 may further include an earphone jack to provide communication between the earphone and the terminal.

WiFi is a short-range wireless transmission technique. The terminal may, for example, send and receive E-mail, browse a webpage and access a streaming media for the user by the WiFi module 907, and provide wireless broadband Internet access for the user. Although the WiFi module 907 is shown in FIG. 9, it can be understood that the WiFi module 907 is not necessary for the terminal, and may be omitted as needed within the scope of the essence of the disclosure.

The processor 908 is a control center of the terminal, which connects various parts of the mobile phone by using various interfaces and wires, and implements various functions and data processing of the terminal by running or executing the software programs and/or modules stored in the memory 902 and invoking data stored in the memory 902, thereby monitoring the mobile phone as a whole. Optionally, the processor 908 may include one or more processing cores. Preferably, an application processor and a modem processor may be integrated into the processor 908. The application processor is mainly used to process, for example, an operating system, a user interface and an application. The modem processor is mainly used to process wireless communication. It can be understood that, the above modem processor may not be integrated into the processor 908.

The terminal further includes a power supply 909 (such as a battery) for powering various components. Preferably, the power supply may be logically connected with the processor 908 via a power management system, therefore, functions such as charging, discharging and power management are implemented by the power management system. The power supply 909 may also include one or more of a DC or AC power supply, a recharging system, a power failure detection circuit, a power converter or an inverter, a power status indicator and any other assemblies.

Although not shown, the terminal may also include other modules such as a camera and a Bluetooth module, which are not described herein. For example, in the embodiments of the disclosure, in order to achieve various functions, the processor 908 in the terminal may load executable files corresponding to processes of one or more application programs, which are to be executed by the processor 908, into the memory 920 based on the following instructions:

loading a script file runtime environment;

setting, in the script file runtime environment, a characteristic function capturing function, correspondence between the characteristic function capturing function and a characteristic function, and a virus characteristic, by loading and running a characteristic script in the script file runtime environment;

searching for the characteristic function in a script to be searched, replacing the characteristic function with the corresponding characteristic function capturing function, and obtaining executable codes in the characteristic function, by loading and running the script to be searched in the script file runtime environment;

determining whether the executable codes meet the virus characteristic; and

reporting that the script to be searched is script virus if the executable codes meet the virus characteristic.

Optionally, there are further instructions of,

setting an initialization characteristic condition in the script file runtime environment by loading and running the characteristic script in the script file runtime environment; and

before the searching for the characteristic function in the script to be searched, determining that the script to be searched meets the initialization characteristic condition by loading and running the script to be searched in the script file runtime environment.

Optionally, the setting an initialization characteristic condition in the script file runtime environment includes:

declaring a characteristic initialization global variable and a characteristic initialization function; and setting a first execution result, which is generated by using the characteristic initialization global variable and calling the characteristic initialization function, as the initialization characteristic condition.

Optionally, the determining whether the script to be searched meets the initialization characteristic condition includes:

generating, by the script to be searched, a second execution result by using the characteristic initialization global variable and calling the characteristic initialization function; determining whether the second execution result is the same as the initialization characteristic condition; determining that the script to be searched meets the initialization characteristic condition if the second execution result is the same as the initialization characteristic condition; and determining that the script to be searched does not meet the initialization characteristic condition if the second execution result is not the same as the initialization characteristic condition.

Optionally, the obtaining the executable codes in the characteristic function includes:

in a case that a function body of the characteristic function is executable codes, obtaining the executable codes in the characteristic function; and

in a case that a sub-function is nested in the function body of the characteristic function, obtaining the executable codes in the characteristic function by running the sub-function in the characteristic function.

Optionally, there are further instructions of, before the running a script to be searched in the script file runtime environment,

determining whether a file to be searched is a script file; in a case that the file to be searched is a script file, taking the file to be searched as the script to be searched; and in a case that the file to be searched is not a script file and the file to be searched includes a script file, extracting the script file from the file to be searched and taking the extracted script file as the script to be searched.

Optionally, there are further instructions of,

in a case that a plurality of characteristic scripts are included in a characteristic virus library, performing, for the plurality of characteristic scripts one by one, the steps of:

setting, in the script file runtime environment, a characteristic function capturing function, correspondence between the characteristic function capturing function and a characteristic function, and a virus characteristic, by loading and running a characteristic script in the script file runtime environment;

searching for the characteristic function in a script to be searched by loading and running the script to be searched in the script file runtime environment, replacing the characteristic function with the corresponding characteristic function capturing function, and obtaining executable codes in the characteristic function;

determining whether the executable codes meet the virus characteristic; and

reporting that the script to be searched is script virus if the executable codes meet the virus characteristic,

until it is reported that the script to be searched is script virus, or the steps are performed for all of the plurality of the characteristic scripts.

In the embodiments of the disclosure, the characteristic script and the script to be searched are loaded and run in the script file runtime environment, and the initialization characteristic condition is preset; if the script to be searched meets the initialization characteristic condition, the script to be searched may be the script virus, and the script to be searched may continue running in a pre-simulated script virus runtime environment until the characteristic function, which is used to execute the executable codes in the characteristic function itself, is found; the characteristic function is replaced with the corresponding characteristic function capturing function, so that the executable codes included in the characteristic function are obtained by the characteristic function capturing function, rather than executed by the characteristic function. In this way, the real executable behavior of the script to be searched is found; and then, by scanning the real executable codes hidden in the script to be searched for the virus characteristic, multiple virus variations having the same malicious behavior can be found by only one characteristic script, therefore, the hit rate for identifying the script virus is increased

It should be noted that, the embodiments of the disclosure are described herein in a progressive manner, with the emphasis of each of the embodiments on the difference from the other embodiments; hence, for the same or similar parts between the embodiments, one can refer to the other embodiments. For the system or device disclosed in the embodiments, the description thereof is relatively simple since it is substantially similar to the methods disclosed in the embodiments, hence, the related parts can refer to the description of the method parts.

It should be noted that, relational terms such as first and second herein are just used to distinguish one entity or operation from another entity or operation, which do not necessarily require or indicate that any of such actual relationship or sequence exists between these entities or operations. In addition, terms “comprise”, “include” or any other variation thereof intends to be understood in a non-exclusive sense, so that a process, a method, an object or a device including a series of elements not only include these elements, but also includes other elements not explicitly listed, or further includes elements inherent in the process, the method, the object or the device. In the absence of more restrictions, element defined by a sentence “include(s) a . . . ” or “comprise(s) a . . . ” does not exclude that other same elements also exist in the process, the method, the object or the device including said element.

Steps of the methods or algorithms according to the embodiments of the disclosure may be implemented by using hardware, software modules executed by a processor, or a combination thereof. The software module may be disposed in a Random Access Memory (RAM), an internal storage, a Read Only Memory (ROM), an Electrically Programmable ROM, an Electrically Erasable Programmable ROM, a register, a hard disk, a removable disk, a CD-ROM or any conventional storage medium.

Those skilled in the art may implement or utilize the invention by the description of the embodiments of the disclosure. Various changes based on the embodiments are apparent for those skilled in the art. The general principle defined in the disclosure may be implemented in other embodiments without departing from the spirit or scope of the disclosure. Therefore, the embodiments in the disclosure are not intent to limit the disclosure, and the disclosure is intent to protect a broadest scope consistent with the principle and novelty disclosed in the disclosure.

1. A method for identifying script virus, comprising:
loading a script file runtime environment;
setting, in the script file runtime environment, a characteristic function capturing function, correspondence between the characteristic function capturing function and a characteristic function, and a virus characteristic, by loading and running a characteristic script in the script file runtime environment;
searching for the characteristic function in a script to be searched, replacing the characteristic function with the corresponding characteristic function capturing function, and obtaining executable codes in the characteristic function, by loading and running the script to be searched in the script file runtime environment;
determining whether the executable codes meet the virus characteristic; and
reporting that the script to be searched is script virus if the executable codes meet the virus characteristic.

2. The method according to claim 1, further comprising:
setting an initialization characteristic condition in the script file runtime environment by loading and running the characteristic script in the script file runtime environment; and
before searching for the characteristic function in the script to be searched, determining that the script to be searched meets the initialization characteristic condition by loading and running the script to be searched in the script file runtime environment.

3. The method according to claim 2, wherein setting an initialization characteristic condition in the script file runtime environment comprises:
declaring a characteristic initialization global variable and a characteristic initialization function; and setting a first execution result, which is generated by using the characteristic initialization global variable and calling the characteristic initialization function, as the initialization characteristic condition.

4. The method according to claim 3, wherein determining whether the script to be searched meets the initialization characteristic condition comprises:
generating, by the script to be searched, a second execution result by using the characteristic initialization global variable and calling the characteristic initialization function; determining whether the second execution result is the same as the initialization characteristic condition; determining that the script to be searched meets the initialization characteristic condition if the second execution result is the same as the initialization characteristic condition; and determining that the script to be searched does not meet the initialization characteristic condition if the second execution result is not the same as the initialization characteristic condition.

5. The method according to claim 1, wherein obtaining the executable codes in the characteristic function comprises:
in a case that a function body of the characteristic function is executable codes, obtaining the executable codes in the characteristic function; and
in a case that a sub-function is nested in the function body of the characteristic function, obtaining the executable codes in the characteristic function by running the sub-function in the characteristic function.

6. The method according to claim 1, further comprising:
before running a script to be searched in the script file runtime environment, determining whether a file to be searched is a script file; in a case that the file to be searched is a script file, taking the file to be searched as the script to be searched; and in a case that the file to be searched is not a script file and the file to be searched comprises a script file, extracting the script file from the file to be searched and taking the extracted script file as the script to be searched.

7. The method according to claim 1, further comprising:
in a case that a plurality of characteristic scripts are included in a characteristic virus library, performing, for the plurality of characteristic scripts one by one, the steps of:
setting, in the script file runtime environment, a characteristic function capturing function, correspondence between the characteristic function capturing function and a characteristic function, and a virus characteristic, by loading and running a characteristic script in the script file runtime environment;
searching for the characteristic function in a script to be searched, replacing the characteristic function with the corresponding characteristic function capturing function, and obtaining executable codes in the characteristic function, by loading and running the script to be searched in the script file runtime environment;
determining whether the executable codes meet the virus characteristic; and
reporting that the script to be searched is script virus if the executable codes meet the virus characteristic,
until it is reported that the script to be searched is script virus, or the steps are performed for all of the plurality of the characteristic scripts.

8. A device for identifying script virus, comprising a hardware processor and a non-transitory storage comprising units comprising:
a loading unit, configured to load a script file runtime environment;
an initialization unit, configured to set, in the script file runtime environment, a characteristic function capturing function, correspondence between the characteristic function capturing function and a characteristic function, and a virus characteristic, by loading and running a characteristic script in the script file runtime environment;
an obtaining unit, configured to search for the characteristic function in a script to be searched, replace the characteristic function with the corresponding characteristic function capturing function, and obtain executable codes in the characteristic function, by loading and running the script to be searched in the script file runtime environment;
a second determination unit, configured to determine whether the executable codes meet the virus characteristic; and
a virus report unit, configured to report that the script to be searched is script virus if the executable codes meet the virus characteristic.

9. The device according to claim 8, wherein the initialization unit is further configured to set an initialization characteristic condition in the script file runtime environment by loading and running the characteristic script in the script file runtime environment;
wherein the device further comprises:
a first determination unit, configured to determine whether the script to be searched meets the initialization characteristic condition by loading and running the script to be searched in the script file runtime environment,
the obtaining unit is configured to, in a case that the script to be searched meets the initialization characteristic condition, search for the characteristic function in the script to be searched, replace the characteristic function with the corresponding characteristic function capturing function, and obtain the executable codes in the characteristic function, by loading and running the script to be searched in the script file runtime environment.

10. The device according to claim 9, wherein the initialization unit comprises:
a first setting sub-unit, configured to, by loading and running the characteristic script in the script file runtime environment, declare a characteristic initialization global variable and a characteristic initialization function, and set a first execution result, which is generated by using the characteristic initialization global variable and calling the characteristic initialization function, as the initialization characteristic condition, in the script file runtime environment; and
a second setting sub-unit, configured to declare the characteristic function capturing function and the correspondence between the characteristic function capturing function and the characteristic function, and set the virus characteristic.

11. The device according to claim 10, wherein the first determination unit is configured to:
by loading and running the script to be searched in the script file runtime environment, generate a second execution result by the script to be searched by using the characteristic initialization global variable and calling the characteristic initialization function; determine whether the second execution result is the same as the initialization characteristic condition; determine that the script to be searched meets the initialization characteristic condition if the second execution result is the same as the initialization characteristic condition; and determine that the script to be searched does not meet the initialization characteristic condition if the second execution result is not the same as the initialization characteristic condition.

12. The device according to claim 8, wherein the obtaining unit comprises:
a searching sub-unit, configured to search for the characteristic function in the script to be searched by loading and running the script to be search in the script file runtime environment;
a replacement sub-unit, configured to replace the characteristic function with the corresponding characteristic function capturing function; and
an obtaining sub-unit, configured to, in a case that a function body of the characteristic function is executable codes, obtain the executable codes in the characteristic function; and in a case that a sub-function is nested in the function body of the characteristic function, obtain the executable codes in the characteristic function by running the sub-function in the characteristic function.

13. The device according to claim 8, wherein the device further comprises:
a script extraction unit, configured to determine whether a file to be searched is a script file; in a case that the file to be searched is a script file, take the file to be searched as the script to be searched; and in a case that the file to be searched is not a script file and the file to be searched comprises a script file, extract the script file from the file to be searched and take the extracted script file as the script to be searched.

14. A system for identifying script virus, comprising:
a characteristic virus library and a virus identification engine,
wherein the characteristic virus library is configured to store a plurality of characteristic scripts; and
the virus identification engine comprises:
a loading unit, configured to load a script file runtime environment;
an initialization unit, configured to set, in the script file runtime environment, a characteristic function capturing function, correspondence between the characteristic function capturing function and a characteristic function, and a virus characteristic, by loading and running a characteristic script in the script file runtime environment;
an obtaining unit, configured to search for the characteristic function in a script to be searched, replace the characteristic function with the corresponding characteristic function capturing function, and obtain executable codes in the characteristic function, by loading and running the script to be searched in the script file runtime environment;
a second determination unit, configured to determine whether the executable codes meet the virus characteristic; and
a virus report unit, configured to report that the script to be searched is script virus if the executable codes meet the virus characteristic.

15. The system according to claim 14, wherein the initialization unit is further configured to set an initialization characteristic condition in the script file runtime environment by loading and running the characteristic script in the script file runtime environment;
wherein the virus identification engine further comprises:
a first determination unit, configured to determine whether the script to be searched meets the initialization characteristic condition by loading and running the script to be searched in the script file runtime environment,
the obtaining unit is configured to, in a case that the script to be searched meets the initialization characteristic condition, search for the characteristic function in the script to be searched, replace the characteristic function with the corresponding characteristic function capturing function, and obtain the executable codes in the characteristic function, by loading and running the script to be searched in the script file runtime environment.

16. The system according to claim 15, wherein the initialization unit comprises:
a first setting sub-unit, configured to, by loading and running the characteristic script in the script file runtime environment, declare a characteristic initialization global variable and a characteristic initialization function, and set a first execution result, which is generated by using the characteristic initialization global variable and calling the characteristic initialization function, as the initialization characteristic condition, in the script file runtime environment; and
a second setting sub-unit, configured to declare the characteristic function capturing function and the correspondence between the characteristic function capturing function and the characteristic function, and set the virus characteristic.

17. The system according to claim 16, wherein the first determination unit is configured to:
by loading and running the script to be searched in the script file runtime environment, generate a second execution result by the script to be searched by using the characteristic initialization global variable and calling the characteristic initialization function; determine whether the second execution result is the same as the initialization characteristic condition; determine that the script to be searched meets the initialization characteristic condition if the second execution result is the same as the initialization characteristic condition; and determine that the script to be searched does not meet the initialization characteristic condition if the second execution result is not the same as the initialization characteristic condition.

18. The system according to claim 14, wherein the obtaining unit comprises:
a searching sub-unit, configured to search for the characteristic function in the script to be searched by loading and running the script to be search in the script file runtime environment;
a replacement sub-unit, configured to replace the characteristic function with the corresponding characteristic function capturing function; and
an obtaining sub-unit, configured to, in a case that a function body of the characteristic function is executable codes, obtain the executable codes in the characteristic function; and in a case that a sub-function is nested in the function body of the characteristic function, obtain the executable codes in the characteristic function by running the sub-function in the characteristic function.

19. The system according to claim 14, wherein the virus identification engine further comprises:
a script extraction unit, configured to determine whether a file to be searched is a script file; in a case that the file to be searched is a script file, take the file to be searched as the script to be searched; and in a case that the file to be searched is not a script file and the file to be searched comprises a script file, extract the script file from the file to be searched and take the extracted script file as the script to be searched.
